(19) United States
(12) Patent Application Publication
(10) Pub. No.: US 2025/0131281 A1
(43) Pub. Date: Apr. 24, 2025

(54) ADVERSARIAL ATTACKS ON PERCEPTION COMPONENTS

(71) Applicant: Five AI Limited, Cambridge (GB)

(72) Inventors: Nicholas A. Lord, Bristol (GB); Luca Bertinetto, Bristol (GB); Romain Mueller, Bristol (GB)

(73) Assignee: Five AI Limited, Cambridge (GB)

(21) Appl. No.: 18/695,786

(22) PCT Filed: Sep. 26, 2022
(86) PCT No.: PCT/EP2022/076689

§ 371 Date: Mar. 26, 2024

(30) Foreign Application Priority Data
Sep. 27, 2021 (GB) 2113771.6
Oct. 5, 2021 (GB) 2114251.8

(51) Int. Cl. G06N 3/094

(52) U.S. Cl. CPC G06N 3/094

(57) ABSTRACT

A computer-implemented method of generating black-box adversarial inputs to a perception component using a surrogate model of the perception component comprises receiving an initial input to the perception component and repeatedly perturbing the initial input until an adversarial input is found that satisfies an attack objective by: performing a primary attack process by perturbing the initial input based on a computed gradient of a surrogate attack loss function of the surrogate model that encodes the attack objective; wherein, if the primary attack process terminates without finding any perturbed input satisfying the promising attack condition, a backup attack process is performed to perform a randomized search of the input space of the perception component, guided by the surrogate model, until a perturbed input satisfying the promising attack condition is found; wherein the primary attack process is repeated based on the perturbed input found by the primary attack process or backup process.

### TECHNICAL FIELD

The present disclosure pertains to adversarial attacks performed on perception components, and to “black-box” adversarial attacks in particular.

### BACKGROUND

A perception component refers generally to a component that is capable of perceiving physical structure captured in an input. One example of a perception component is a suitably trained convolutional neural network. In computer vision applications, such inputs may take the form of conventional images. However, the techniques described herein can also be applied to other forms of input (such as point clouds, voxel tensors, surface meshes, or any other input in which perceivable physical structure is captured etc.). Such inputs may capture physical structure in two or three spatial dimensions. Perception includes computer vision, including cameras as well as other perception modalities such as radar, lidar, etc.

An “attack” on a perception component (the ‘victim’) means finding some “small” perturbation to an input that “fools” the perception component. Typically, this means a change that would not be readily perceptible to a human. For example, in the case of a perception component that classifies inputs in relation to predefined classes, finding a small perturbation that causes the perturbed input to be mis-classified (“flipping” the class label) would amount to a successful attack. Such attacks are a useful analytical tool, allowing problems with perception components to be identified and mitigated (e.g. through re-training, re-architecting or otherwise reconfiguring the perception component). As another example, a successful attack on an object detector might involve a perturbation to the input that causes a “missed” detection (false negative) or a false positive detection.

A “query” in this context generally means providing some input to the perception component and receiving a computed output. In score-based attacks, it is assumed that the received output comprises at least one score (such as a classification score or scores). For example, a query might involve providing a perturbed input to a perception component to check whether a successful attack has been found (e.g., whether the class label has been successfully flipped) or whether the perturbation is promising given a particular attack objective (e.g., if the objective is to flip the class label, a “promising” perturbation might be one that decreases the score for the ‘correct’ class to which the original input is assigned, or one that increases the score for a specific class other than the correct class). Query efficiency refers to the number of queries on the victim required to achieve a successful attack.

### SUMMARY

An aim herein is to provide a method that can be used to find successful attacks on a victim perception component over a range of inputs with a reduced number of queries on the victim. The method is “black box” in that it only requires the ability to query the victim and obtain at least one output score for a given input; full, analytical “white box” access to the victim is not required (although, as explained below, there are benefits to the method even in situations where white box access to the victim is available).

The method is based on a “surrogate” (proxy) model(s) of the perception component (e.g. having the same output space as the victim, and a reasonably similar architecture and training set), on which an attack loss function can be defined, and for which a gradient of the attack loss with respect to the input can be computed (typically analytically, via backpropagation through the surrogate model). Surrogate models are known in the context of adversarial attacks, and are discussed in further detail below.

A first aspect herein provides a computer-implemented method of generating black-box adversarial inputs in an input space of a perception component using one or more surrogate models of the perception component, the method comprising: receiving an initial input to the perception component and one or more output scores computed by the perception component from the initial input; repeatedly perturbing the initial input until an adversarial input is found that satisfies an attack objective when inputted to the perception component, the initial input repeatedly perturbed by: performing a primary attack process based on the initial input, to compute one or more perturbed inputs, each perturbed input computed in the primary attack process by evaluating a gradient of a surrogate attack loss function based on the initial input, and perturbing the initial input based on the gradient of the surrogate attack loss function, the surrogate attack loss function encoding the attack objective in terms of one or more output scores computed by a surrogate model of the one or more surrogate models. Ff a perturbed input of the one or more perturbed inputs is determined to satisfy a promising attack condition, the primary attack process is repeated based on that perturbed input, wherein it is determined whether the perturbed input satisfies the promising attack condition by comparing the one or more scores computed by the perception component from the initial input with one or more scores computed by the perception component from the perturbed input. If the primary attack process terminates without finding any perturbed input satisfying the promising attack condition: (i) a backup attack process is performed, which is a search of the input space of the perception component for perturbed inputs satisfying the promising attack condition that is randomized but guided by the one or more surrogate models, until a perturbed input satisfying the promising attack condition is found, and (ii) the primary attack process is repeated based on the perturbed input found to satisfy the promising attack condition in the backup attack process.

Conceptually, each input may be regarded as a point in the input space, and each perturbation as a vector in a direction from a given point in the input space.

The method is iterative. In each iteration, the aim is to find some perturbation that is promising (in the above sense) given the attack objective. Typically, multiple iterations will be needed until a successful attack is found. So, the first iteration starts from some initial input and attempts to find some perturbation to the initial input that is promising. The perturbed input found at the end of the first iteration is the starting point for the next iteration, which attempts to find some further perturbation to the perturbed input from the previous iteration that is promising, and so on until a successful attack (that is, some final perturbed input satisfying the attack objective) is found (or some other termination criterion is met, such as a query limit).

Each iteration proceeds in the same way from its given starting input (the initial input for the first iteration, and, for every subsequent iteration, the perturbed input found to satisfy the promising attack condition in the previous iteration). First, the method attempts to find a promising perturbation to the starting input using the primary attack process, based on the gradient of the surrogate loss function evaluated at the starting input. The primary attack process is not guaranteed to find a promising perturbation. In the event it fails to do so, that iteration reverts to the backup attack process, which is randomized but still guided by the surrogate model(s). The randomization in the second phase diversifies the search process, and it is more or less guaranteed that the backup process would be able to find a promising attack direction eventually; the use of the surrogate model(s) in the backup attack processes reduces the average number of queries on the victim required to reach that point, in the event the backup attack process is required in a given iteration.

In practice, a small failure rate may be accepted. For example, one possible strategy terminates the search on a given example once a query cap (e.g. in the region of 10,000) has been exceeded. Alternative implementations for the backup process could use increasingly less constrained searches, or run searches longer, with essentially guaranteed success, assuming that the victim model suffers the vulnerability that the attacker is looking to expose, as is typical for most commonly used models.

Hence, the outcome of a given iteration is a promising perturbation that has been found either in the primary attack process or, failing that, the backup attack process. Either way, that perturbation is the starting point for the next iteration.

The method uses “online” surrogate(s), in that it is assumed a gradient of the surrogate can be obtained for any given input (that is, at any point in the input space), as required in a given iteration of the algorithm. For example, the gradient may be computed analytically, via back-propagation through the surrogate model.

The method has been demonstrated empirically to exceed the performance of state of the art methods, as measured in terms of query efficiency.

In embodiments, the gradient of the surrogate loss function may be normalized.

In each iteration, the primary attack process may compute the (or each) perturbed input by applying a perturbation to the starting input in a direction in the input space that is defined by the gradient of the surrogate loss function.

For example, up to (that is, a maximum of) two perturbations may be applied to the starting input in each iteration, in the direction of the gradient and in the opposite direction respectively. For example, a first perturbation may be applied in one of those directions and, if that does not result in a successful attack, a second perturbation may be applied in the other of those directions.

The (or each) perturbation may have a fixed magnitude.

The promising attack condition may be defined in terms of a victim attack loss function (Lᵥ) defined in terms of one or more output scores of the victim.

The primary attack process may perform a number of queries on the victim that is defined by the number of surrogate models and the number of directions considered for each gradient of the surrogate attack loss function. For example, in the described embodiments, two directions are considered for each gradient, for each surrogate model. Hence, up to 2N queries are performed in the primary attack process in each iteration, where N is the number of surrogate models. The backup process may not be limited in this way. For example, the backup process may be capable of considering a (theoretically) unlimited number of directions. The backup process may be limited by a query cap or other predetermined termination condition.

The surrogate attack loss function that encodes the attack objective may be a deterministic (non-randomized) function of one or more output scores of the surrogate model.

The backup attack process can take various forms. There are various known black box attack methods that use online surrogate(s) to guide a randomized search.

For example, in each iteration of the backup attack process, each perturbed input may be computed by perturbing the starting input based on a gradient of a randomized transformation of one or more output scores of a surrogate model.

In the examples described below, the backup attack process uses a known Output-Diversified Sampling (ODS) approach, as taught in Tashiro et al. (2020).

As further examples, the backup attack process may use a bandit optimiser supplied with surrogate gradients (e.g. as in Guo et al. (2019b)) or use surrogate gradients as a biasing prior (e.g. as in Cheng et al. (2019)). See below for further details.

A query on the victim may be performed for a given perturbed input to determine whether the input fulfils the attack objective and, failing that, whether the perturbed input satisfies the promising attack condition.

The method may comprise identifying and mitigating a problem with the perception component based on the adversarial input(s) that has been found.

For example, the perception component may be modified (e.g. through re-training, re-architecting or otherwise reconfiguring the perception component) so that the adversarial input no longer satisfies the attack objective (in other words, so that the perception component is no longer ‘fooled’ by the perturbed input).

Each input may, for example, comprise one of the following modalities of perception data, or any combination thereof: image data, lidar data or radar data.

The perception component may be for use in a robotic system for perceiving physical structure in an environment in which the robot system is operating.

For example, the method may comprise incorporating the above-mentioned modified perception component in a robotic system.

The following description may refer to the inputs as “vector inputs”, and the perturbations as “perturbation vectors”. Conceptually, each input is interpreted as a point in the input vector space, and each perturbation is interpreted as a translation of that point. This does not necessarily imply that the inputs are represented as vectors at the data level (e.g. the inputs could take the form of images, points clouds, voxel tensors etc.). The following description refers to images by way of example, but it will be appreciated that the inputs can take other forms, such as those mentioned previously. An attack direction encapsulates a perturbation pattern to be applied to the input.

The perturbations are also “images” (or, more generally, perception inputs) of a sort, albeit images/inputs that would generally be used to transform other inputs. Images are referred to by way of example, but the description applies equally to other forms of perception input. Images and perturbations may be “flattened” into a vector according to a fixed convention which orders the coordinates. That is, rather than treating the image as a grid, it may be treated as a point in a high-dimensional Euclidean space. This allows e.g. a fixed perturbation to be computed in Euclidean space, which in turn can be applied to the original images by transforming the perturbation back to the original image representation (e.g. an (R, C, 3) grid used for representing colour images).

One application of transfer-based adversarial attack methods is to provide a form of sensitivity analysis. Surrogate-based adversarial attacks form the basis of sensitivity analysis: determining whether the victim model is sensitive to the same features/directions as the surrogate(s)).

A second aspect herein provides a method of developing a perception system, the method comprising: applying a modification to a perception system, and thereby obtaining a modified perception system; and performing a sensitivity analysis, using a surrogate-based adversarial attack method, in which one of the perception system and the modified perception system is used as a surrogate, to attempt to formulate one or more adversarial attacks on the other.

The method may comprise applying a further modification to the modified perception system based on results of the sensitivity analysis. For example, a further modification may be applied based on one or more successful attacks determined in the sensitivity analysis, or responsive to a failure of the surrogate-based adversarial attack method.

Preferably, the method of the first aspect is used in embodiments of the second aspect. However, any surrogate-based attack method may be used in the second aspect.

### BRIEF DESCRIPTION OF FIGURES

For a better understanding of the present disclosure, and to show how embodiments of the same may be carried into effect, reference is made by way of example only to the following figures in which:

FIG. 1 shows a perturbation applied to an image represented in an input vector space of a perception component;

FIGS. 2-6 show experimental results for an adversarial black-box attack algorithm described herein; and

FIG. 7 shows a functional block diagram of a computer system for implementing a black box adversarial attack method;

FIG. 8 shows the transfer of information from a surrogate to a target according to the method described herein.

### DETAILED DESCRIPTION

Recent work on black-box adversarial attack methods has recognised the benefits of incorporating both the surrogate gradient information usually associated with transfer-based methods and the flexible query-based numerical optimization typical of score-based methods. However, existing methods of this type underperform their potential and are often overly complicated besides. Herein described is a short and simple algorithm which achieves state-of-the-art results by attempting iterative ascent in the direction of the surrogate's loss gradient, and, only when that fails to proceed, sampling alternative search directions from the coimage of the surrogate's local linearization, i.e. its Jacobian's row space. The former directions produce very low query counts, while the latter serve as a ‘softer’ backup for the cases in which more direct transfer fails, delivering very low failure rates. Beyond the fact that this method serves as a fast and practical attack when scores and surrogates are available, experiments demonstrate the empirical correctness of the method's assumption that the studied networks are in an important sense learning similar functions to one another, making the attack problem under this threat model easy.

Example embodiments are described below. First some further relevant context to the described embodiments is provided. A list of references referred to in the text is provided at the end of the description.

The paper that introduced adversarial examples in computer vision (Szegedy et al., 2014) also initiated the study of their transfer across models. Accordingly, the first papers to propose black-box attacks (Papernot et al., 2017; Liu et al., 2017) did so within a transfer-based framework, typically using a simple “fast-gradient” optimization with gradients supplied by a surrogate model. This allowed them to assume nothing about the attacked models except their input and output domains and, of course, that they would return the top predicted class for a given input image. This stood in contrast to white-box (or “first-order oracle”) approaches, e.g. Goodfellow et al. (2014); Moosavi-Dezfooli et al. (2016); Carlini & Wagner (2017), which assumed full knowledge of the victim model (notably its gradients) while typically seeking to minimise the norm of the adversary and/or the compute time spent finding it. The transfer-based black-box methods instead assumed comparable knowledge of the surrogate, whether provided directly, trained on a similar data distribution, or constructed iteratively by matching the observed behaviour of the victim over repeated queries to it. While these methods demonstrated that some amount of transfer between different networks was feasible, the field widely acknowledged that they fell short of reliable success, and sought alternatives.

For Chen et al. (2017) and Bhagoji et al. (2018), the alternative involved a modification of the threat model: they assumed the victim to provide not only the top class prediction but also its class score/confidence, and perhaps the scores assigned to the other candidate classes as well. This relaxation of the threat model allowed for doing away with the need to acquire or construct surrogates of the victim, instead using numerical query-based methods to estimate the victim's gradients directly. These approaches and their many descendants are called “score-based” attacks, operating within the “zeroth-order oracle” setting. The common problem they all face, noted in the seminal works above, is that direct numerical estimation of gradients is linear in the dimension of the input space. Depending on the input image resolution, this ranges from being costly to being infeasible. Thus, a core issue in score-based attacks is the reduction of the query count while maintaining the quality of the gradient estimate: in Chen et al. (2017) alone, proposals included coordinate descent, basis transformation, coarse-to-fine optimization, attention, and priors on the dominant components and/or structure of the gradient. The line of work which followed (Ilyas et al., 2018; 2019; Li et al., 2019; Liu et al., 13 2020; Guo et al., 2019b; Tu et al., 2019) explored ways to improve the fundamental approach by experimenting with different optimization methods and priors. Strikingly, and perhaps surprisingly, one of the most successful efforts was SimBA (Guo et al., 2019a), for “Simple Black-Box Attack”. Its name derives from the fact that it is an especially basic form of coordinate descent which achieves competitive results despite its deliberately simple approach: the greedy sequential assignment of signs to fixed-length steps along orthogonal basis directions.

Though query-driven score-based black-box attacks were proposed as an alternative to transfer methods, the two approaches are not incompatible with one another. They are actually complementary: a query-based strategy can benefit from search directions that are more promising a priori, and a transfer-based strategy can benefit from flexible optimization that allows it to dynamically correct approximation errors and consider alternative hypotheses. This was first suggested in contemporaneous works by Cheng et al. (2019) and Guo et al. (2019b), which were followed by Tashiro et al. (2020) and Yang et al. (2020).

The approach described herein is based on a belief that the core intuition of this branch of literature is sound. However, when combining transfer- and query-based approaches, it is crucial to recognise that the failure of surrogate gradient transfer is generally overestimated, even by approaches which leverage it. Transfer generally succeeds: it merely requires an occasional source of appropriately chosen alternative hypotheses in order to avoid optimization failure. It is this core insight that enables a simple but powerful new algorithm which achieves state-of-the-art results against the most modern competing methods on this problem, under their own experimental setup of minimising the number of queries required to identify [symbol] ₂-norm-bounded adversarial perturbations. The approach described herein is called “GFCS: Gradient First, Coimage Second”.

This approach is straightforward in both principle and implementation. Each iteration, it attempts up to two fixed-length steps along a given direction. So long as it yields a successful update, this candidate direction is simply the normalised adversarial loss gradient of a surrogate model. If the method is unable to accept any step in this direction, it instead samples randomly weighted sums of surrogate class-score gradients until one such direction yields a successful update, at which point it reverts to using surrogate adversarial loss gradients as before. All of the “backup” direction proposals are thus drawn from the row space of the surrogate's Jacobian, which is called the “coimage” of the linearised surrogate. Intuitively, this represents the subspace of directions at the current point that the surrogate has any response to at all. As demonstrated further herein, GFCS is able to overwhelmingly rely on surrogate loss gradients, a fact which accounts for its extreme efficiency. The coimage search, on the other hand, plays a diversifying role which is necessary for achieving the method's high success rate, but without imposing an excessive cost. This is possible because its dimension is bounded above by that of the network's output space, and is thus generally drastically lower in dimension than the input image embedding space, e.g. 1000-D vs. 268203-D for the common ImageNet Inception V3 implementation. Beyond the success of the attack in its own right, the existence of such a fast and effective attack which relies entirely on surrogate output gradients indicates that the studied networks are, in an important sense, very similar to one another.

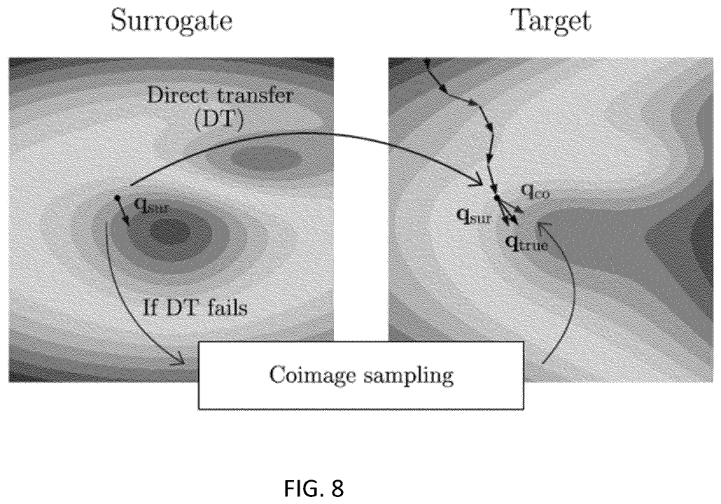

FIG. 8 shows a transfer of information from a surrogate to a target in the present GFCS method. A sequence of optimization steps is taken through the loss landscape of the target model, as shown on the right. Each candidate direction q is supplied by the surrogate in one of two ways: either through direct transfer of the surrogate's own gradient qₛᵤᵣ, or as a q_{co} generated through a process of coimage sampling described further below. qₜᵣᵤₑ is the target's true but inaccessible gradient. As shown in the experiments described below, the method relies mostly on the directly transferred qₛᵤᵣs, using the q_{co}s to avoid failure.

Cheng et al. (2019) and Guo et al. (2019b) were the first to, in their words, “bridge the gap between the transfer-based attacks and the query-based ones” in the score-based black-box context, noting that earlier methods “often suffer from low attack success rates (in the transfer case) or poor query efficiency (in the query-based case) since it is non-trivial to estimate the gradient in a high-dimensional space with limited information”. Guo et al. (2019b) did this by supplying a bandits optimiser (as used in Ilyas et al. (2019)) with surrogate gradient estimates at each iteration, diversifying the proposed search directions through the use of test-time dropout and drop-layer. Cheng et al. (2019) presented a variant of random gradient-free optimization using the surrogate gradient as a biasing prior (P-RGF) and featuring a dynamically estimated bias parameter, albeit one whose optimal value itself depends on the unknown target gradient. The Output-Diversified Sampling (ODS) approach of Tashiro et al. (2020) sampled gradients of randomly weighted logit sums over multiple surrogate models in order to generate search directions for variations on SimBA, RGF, and some Boundary Attack (Brendel et al., 2018) variants, demonstrating improvement over all of the base methods. Yang et al. (2020) also proposed a surrogate-enhanced version of SimBA (“SimBA++”), sampling candidate pixels to perturb according to the distribution specified by the corresponding magnitudes of the surrogate gradient components, as well as making periodic attempts to directly transfer surrogate gradients estimated using smoothing and momentum. When combined with “High Order Gradient Approximation”, a method for dynamically updating the surrogate by matching the first- and zeroth-order victim model behaviour, it is dubbed “Learnable Black-Box Attack” (LeBA).

In addition to the above, other works on black-box attacks are briefly discussed, particularly score-based methods that use (possibly learned) prior information and/or alternative optimisers. When they feature a relevant concept, variations of the Boundary Attack method of Brendel et al. (2018) are also included, which avoid requiring scores in exchange for much higher query counts:

Frequency/scale priors: As noted by (Chen et al., 2017; Bhagoji et al., 2018), in order to be practical, any black-box method that relies on gradient estimation must have an approach to effectively reduce the intrinsic dimension of the estimate space. Guo et al. (2019a; 2020) use low-frequency DCT dimensions for this purpose. The Boundary Attack variant of Brunner et al. (2019) uses Perlin noise similarly, and the Gaussian smoothing of the gradient in Yang et al. (2020) is conceptually related. Also closely related to the low-frequency prior is the use of spatial downsampling, whether applied to the image or its gradient, and whether implemented through pooling, interpolation, or striding: Tu et al. (2019); Ilyas et al. (2019); Li et al. (2019); Wang et al. (2021) all involve a version of it. Coarse-to-fine approaches, in which results at a coarser scale either solve the problem or initialise the optimiser of a finer one, appear in Moon et al. (2019); Al-Dujaili & O'Reilly (2020).

Data distribution modelling: Li et al. (2019) assumes the ability to parametrically model an adversarial distribution in the vicinity of the input point. Dolatabadi et al. (2020) replaces this parametric model with a normalising flow model trained on clean data. Tu et al. (2019) represents the data using an autoencoder and conducts the attack in its latent space. Huang & Zhang (2020) likewise conducts a latent-space attack, but in that of an encoder-decoder network trained to output adversaries on a source network.

Attention: Wang et al. (2021) uses the output of CAM (Zhou et al., 2016) on a proxy net as a map of pixels to attack. In Brunner et al. (2019), a similar map is derived from the difference between the adversarial and original images, and used to weight the sampled perturbation elementwise.

Gradient/feature priors: The use of gradient priors in Guo et al. (2019b); Cheng et al. (2019); Tashiro et al. (2020); Yang et al. (2020) is discussed above, and the transfer-based approaches Papernot et al. (2017); Liu et al. (2017) are of course fundamentally based on this. Besides these, the method of Brunner et al. (2019) uses the gradient of a surrogate model to bias the orthogonal perturbation used in Boundary Attack, stating, “even surrogate models that are too weak for direct transfer attacks can be used in our framework”. Yan et al. (2021), also a Boundary Attack variant, attempts to learn to mimic the gradients of a victim net using a customised pre-trained policy network. Huang & Zhang (2020) learns a latent space of transferable adversarial features from its surrogate. Andriushchenko et al. (2020) supplies a bespoke feature bank which essentially transfers empirical domain knowledge (i.e. features determined to be likely to fool CNNs), both in the initialisation (vertical stripes) and the feature choice (homogeneous squares in the [symbol] _{∞} case, pairs of opposite-signed “decaying peaks” in the [symbol] ₂). Sahu et al. (2020) attempts to perform a “black-box FGSM” by learning correlations between components of the loss function gradient within a Gaussian Markov random field framework. The “gradient priors” of Ilyas et al. (2019) essentially amount to momentum and downsampling, and do not represent the sort of “flexible gradient transfer” otherwise discussed here.

Optimization algorithms: As explained previously, a standard optimization framework for black-box score-based attacks is ascent on gradients estimated via numerical derivatives in guessed directions, possibly guided by priors and/or using enhancements or simplifications such as coordinate ascent. The aforementioned SimBA variants (including the method presented herein) are considered to essentially be of this type. Variations on or alternatives to this approach have included bandits (Ilyas et al., 2019; Guo et al., 2019b), Natural Evolution Strategies (NES) (Li et al., 2019; Huang & Zhang, 2020; Dolatabadi et al., 2020) evolutionary algorithms (Liu et al., 2020; Wang et al., 2021), and training of a policy network by REINFORCE (Yan et al., 2021). Al-Dujaili & O'Reilly (2020) uses a custom “flip/revert” approach based on checking the overall effect of grouped sign changes to pixel perturbations. By assuming submodularity, Moon et al. (2019) uses the max-heap-based “local search algorithm” to alternate between greedily inserting and removing elements defining a partition between positively and negatively signed perturbation pixels. Shi et al. (2019) comprises a set of optimization heuristics meant to reduce the norms of attacks based on transfer from surrogate models: many of these are in principle applicable to attack vectors obtained otherwise.

### Motivation

One crucial difference between the GFCS method herein and that of the preprint of Ma et al. (2020) rests in the use of coimage transfer, here in the form of ODS. Ma et al. (2020) instead uses standard RGF gradient estimation for this stage, falling prey to the curse of dimensionality pointed out in this context as far back as Chen et al. (2017). Given the ubiquity of linear methods in deep networks, and particularly adversarial attacks, a simple way of viewing this issue is through the rank-nullity theorem of linear algebra. This points out that for linear transformation T mapping finite-dimensional vector space V to vector space W, rank (T)+nullity (T)=dim (V), where rank (T): =dim (image (T)) and nullity (T): =dim (kernel (T)). That is to say, the dimension of the input subspace that has any effect on the output (rank (T)) is no greater than that of the output space (because dim (image (T))≤dim (W)), and the dimension of the input subspace that has no effect on the output (nullity (T)) is at least equal to the difference between the input and output dimensions (because nullity (T)=dim (V)−rank (T)≥dim (V)−dim (W)). To make this more concrete, in the case of a standard ImageNet InceptionV3 network, V=R^{299*299*3} and W=R¹⁰⁰⁰, and so in the linear approximation, rank (T)=dim (coimage (T))≤1000, and nullity (T)≥267203. Under the assumption that the features to which a surrogate is locally sensitive will largely transfer to a target network, naive search of the input space is thus extremely wasteful. Owing to that fact, Ma et al. (2020) is not able to achieve competitive results on TinyImageNet, and does not present any results on ImageNet. By contrast, state-of-the-art results are achieved on ImageNet for the methods described below, demonstrating that the underlying assumption of coimage transfer holds for the networks used to measure performance in the papers against which the present methods are compared.

### Adversarial Attacks—Overview

Given input x, and a classification model that provides confidence scores p_{y}′(x) for each class y′∈Y, an attack can be formulated in terms of some perturbation z to the original input x:

p_{y}′(x+z;θ)

Here, Y is the set of classes over which the model is defined, and θ denotes the parameters of the model (omitted below for conciseness). This can be generalized to other types of score/model. For example, the attack could be formulated with respect to detection confidence score associated with object detection, where a successful attack results in a “missed” detection (e.g. confidence score below some detection threshold).

Here, y denotes the “correct” class label for x, e.g. the class label with the highest p_{y}(x) (the perception component's class prediction for the original, unperturbed input x).

A successful attack on the classification model can be described as perturbing the input x so as to “flip” the class label. That is to say, one attack objective might be to find z such that the perturbed input is mis-classified:

p_{y′}(x+z)>p_{y}(x+z)

for either a specific y′≠y (targeted attack) or any y′≠y (untargeted attack).

Other examples of attacks/attack losses are considered below.

Generally, given a classifier function ƒ(x), the goal is to supply an “adversarial example” x_{adv} which, while “near” to a given xᵢₙ under some definition, is such that ƒ(x_{adv}) differs from ƒ(xᵢₙ) in some desired respect. In image classification, ƒ is a network mapping a D-dimensional input image to a C-dimensional class-score (AKA “logit”) vector. The “untargeted” attack objective, then, is argmax_{c} f_{c}(x_{adv})≠argmax_{c} f_{c}(xᵢₙ), i.e. that the top predicted class y′ of x_{adv} is different from the top predicted class y of xᵢₙ. The “targeted” attack objective is argmax_{c} f_{c}(x_{adv})=t, meaning that the net predicts a specific target class t other than the original prediction argmax f_{c}(xᵢₙ). As the subfield has expanded to consider perturbation classes including non-rigid deformation (Xiao et al., 2018), semantically insignificant distortion (Hosseini & Poovendran, 2018; Brown et al., 2018), and movement within the estimated natural image manifold (Zhao et al., 2018; Hendrycks et al., 2021), corresponding definitions of adversarial perturbation magnitude have been adopted, including total variation and manual human assessment. The most common measure, used by all existing methods used for comparison herein, is ∥xᵢₙ−x_{adv}∥ₚ, with p∈{2, ∞}, with p=2 used herein. In some formulations/experimental setups, the attacker's goal is to satisfy the adversarial objective while minimising the perturbation magnitude. In others, it is to minimise the number of network evaluations performed while finding any adversarial example with a perturbation magnitude within a pre-specified bound. In black-box attacks, the latter setup is common, with the key quantity of interest being the number of evaluations (“queries”) of the victim model: this is likewise a focus of the described embodiments.

An attack loss l(x) is defined so as to encode an attack objective. In the examples below, Lᵥ denotes an attack loss formulated on a victim network ν and Lₛ denotes an attack loss formulated on a surrogate s.

There are various ways of defining an attack loss l(x) to encode a given attack objective. Typically, the attack loss is defined on a single score produced by the perception component. For example, a classification perception component might output probabilities (normalized scores) across a set of perception classes Y (e.g. image classes); typically, the attack loss l(x) is formulated with respect to only one of those classes. However, in other implementations, an attack loss may be based on one or multiple scores. Note that an attack loss can be evaluated even with only black box access (even if white box access is needed to analytically differentiate it with respect to the input).

In the following examples, the aim is to minimize the attack loss l(x) with respect to the input x. As will be appreciated, this can also be described as maximizing the attack loss −l(x). For a targeted attack on a classification component, the attack loss may, for example, be defined as

l_{y′}(x)=−p_{y′}(x)

such that the aim is to maximize the probability of the specific class y′ (or, equivalently, minimize the negative of that probability). For an untargeted attack, the attack loss may, for example, be defined as

l_{y}(x)=p_{y}(x)

such that the aim is to minimize the probability of the correct class y.

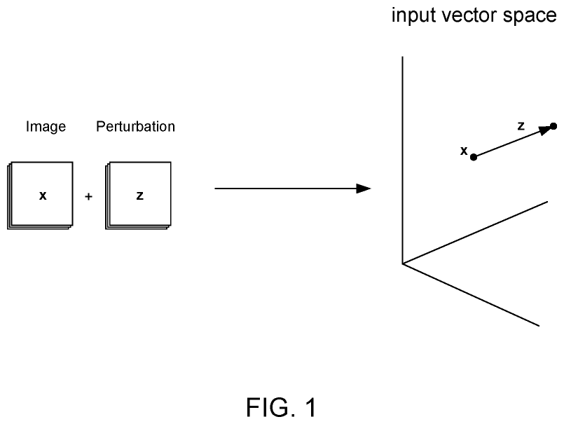

FIG. 1 shows how a perturbation to an image x may be characterized as a perturbation vector z in an input space of a perception model. Three dimensions are depicted but the input space can have any number of dimensions, including much higher dimensionality than three.

A spatial representation of x would typically be inputted to the model (perception component). For example, a W×H×D tensor where D (the depth/number of channels) is 3 for an RGB colour image. However, within the attack framework, the input x is treated as a point in an input space of dimensionality N=WHD, and the perturbation z as a vector translation of the point x in the input space (see FIG. 1).

The above is a useful characterization, as the direction of an attack vector z towards an attack boundary in the input space has been found to be more useful in guiding future attacks than the magnitude of the attack vector z. For this reason, it is useful to express the attack vector z as:

z=∈q,

where ∈=∥z∥ (the magnitude of z) and q is a unit vector in the direction of z.

The example algorithm described below selects a direction q and considers two fixed-magnitude perturbations {+∈q, −∈q} in either direction. However, this is merely one possible implementation, and other implementations may consider a single perturbation or more than two perturbations and/or perturbations of different magnitudes for a given direction q.

“White box” access to the perception component (or a proxy component) means that the gradient of the attack loss ∇ₓl(x) can be computed analytically with respect to input x, e.g. via backpropagation. Whilst superficially similar to training, the present application is quite different. In training, the gradient of a training loss is with respect to weights/parameters θ of the perception component, and is used to find optimal parameters/weights for the perception component; in the present context, any weight/parameters θ of the perception component are fixed, and the gradient is with respect to the input x, with the objective of finding inputs x_{adv} that are “optimal” in the sense of meeting the attack objective.

A full white box attack would typically involve a combination of backpropagation and gradient descent (or ascent, depending on whichever arbitrary convention is adopted), in order to find some input x that optimizes the attack loss l(x). This would typically continue until the attack objective is fulfilled, e.g. by flipping the class label.

The described method does not require white box access to the victim perception component. However, it is assumed that full white box access to the surrogate model(s) is available.

A black box attack (BA) does not rely on computation of the gradients with respect to the surrogate model. The described method is black box because it only assumes white box access to the surrogate(s).

Note the present black box method may be useful even when white box access to the victim network is available. For example, certain neural networks might output scores that are capable of changing discontinuously as a function of the input to the network. An issue can arise with analytical methods in this case. To illustrate this, consider an extreme example, where the attack loss varies as a “staircase”-like function, jumping discontinuously between locally constant values. At the vast majority of points in the input space, the gradient is zero (because the attack loss is locally constant), which provides no insights into promising attack directions. What is needed in this case is a more global view of the attack loss.

A numerical, black box method can be applied in this context, and will effectively “smooth” the attack loss, to provide more useful gradient information than an analytical, white box method.

The staircase example is somewhat artificial. However, neural networks can exhibit similar issues (albeit generally less extreme) in practice. For example, it is not uncommon for a “hack” to be applied to a neural network, in order to correct some specific issue (e.g. to correct some specific unwanted sensitivity to particular input structure), trying not to modify the rest of the network, and this can result in a degree of discontinuous behaviour.

Of course, another benefit of black box attacks is that they do not require white box access and can be used when white box access is not available or is infeasible.

The surrogate (proxy) model could take the form of a model trained over the same perception classes as a “target” perception component to be attacked (and preferably reasonably similar data). If the training set of the target perception component is known, the same training set can be used to train the proxy model, although this is not essential, as evidence suggests that networks trained on the same or similar training objectives but on different training sets will nevertheless generalize in a similar manner.

### Algorithm

Algorithm 1 GFCS: Gradient First, Coimage Second

| 1: | Input: A targeted image xᵢₙ, loss function L, a victim classifier v, a set of surrogate models S, a | |
|---|---|---|
| | step length ϵ, and a norm bound v. | |
| 2: | Output: adversarial image x_{adv} Within distance v of xᵢₙ | |
| 3: | x_{adv} ← xᵢₙ | |
| 4: | Sᵣₑₘ ← S | |
| 5: | while x_{adv} is not adversary do | |
| 6: | if Sᵣₑₘ ≠ 0 then | |
| 7: | Randomly sample surrogate model s from Sᵣₑₘ | |
| 8: | Sᵣₑₘ ← Sᵣₑₘ \ s | |
| 9: | $q ← \frac{{∇}_{x} {L}_{s} ( {x}_{adv} )}{{‖ {∇}_{x} {L}_{s} ( {x}_{adv} ) ‖}_{2}}$ | |
| 10: | else | [symbol] None of the surrogate loss gradients work, so revert to ODS. |
| 11: | Randomly sample surrogate model s from S | |
| 12: | Sample w ~ U(−1, 1)^{C} | |
| 13: | q ← d_{ODS} (x_{adv}, s, w) | [symbol] See Eqn. [symbol] for definition. |

| | |
|---|---|
| 14: | for α ∈ {ϵ, −ϵ} do |
| 15: | if Lᵥ(Πₓ_{ᵢₙ}_{,v} (x_{adv} + α · q)) > Lᵥ (x_{adv}) then |
| 16: | x_{adv} ← Πₓ_{ᵢₙ}_{,v} (x_{adv} + α · q) |
| 17: | Sᵣₑₘ ← S [symbol] Reset candidate surrogate set to input set; resume using loss gradients. |
| 18: | break |

The GFCS method is summarized in pseudocode as Algorithm 1. As indicated above, the method takes a victim classifier v, an input image xᵢₙ, and a norm bound v. The projection operator Πₓ_{ᵢₙ}_{,y} confines its input to the v-ball centred on xᵢₙ: its inclusion in the algorithm represents a standard projected gradient ascent (PGA) implementation. Additionally, the method requires a loss function L, a non-empty set of surrogate models S, and a step length E. E represents the fixed length of the forward and backward perturbations to be attempted at each iterate along its candidate direction, just as in SimBA and its variations. L can be any function of the iterate that the user believes serves as a suitable proxy for the satisfaction of the relevant adversarial objective, as described above: the only requirement here is that it be once differentiable, as its gradient appears in the algorithm. In the present example, a margin loss is used: L_{f}(x)=f_{c}_{ₜ}(x)−f_{c}_{ₛ}(x) where cₛ=argmax_{c} ν_{c}(x) and cₜ=argmax_{c≠c}_{ₛ} ν_{c}(x), i.e. the difference between the highest and second-highest (or, in the targeted case, the target) class scores. Note that the class IDs are defined by the ranking according to v, but are evaluated on the network f parametrizing the loss, which may or may not be v: both Lᵥ and Lₛ appear in the algorithm, both direct queries of the victim and evaluations of the surrogate gradients are needed. The natural assumption of a surrogate method is that the surrogate will provide useful information about the victim, but there is no “hard” requirement on the surrogates s∈S other than being once-differentiable functions mapping the space of inputs to the space of outputs. The definition of “ODS direction” d_{ODS} for network f and input x is, as in Tashiro et al. (2020):

$${d}_{ODS} ( x , f , w ) = \frac{{∇}_{x} ( {w}^{T} f ( x ) )}{{‖ {∇}_{x} ( {w}^{T} f ( x ) ) ‖}_{2}} ; \qquad ( 1 )$$

where w is sampled from the uniform distribution over [−1, 1]^{C}, where C is the number of possible classes. By definition, it is the normalised gradient of a randomly weighted sum of all of the class scores. Equivalently, by linearity, it is a randomly weighted sum of all of the class-score gradients (i.e. Jacobian rows), which are themselves a basis of the coimage of the linear approximation of f: the subspace which f exhibits any nonzero response to.

As described above, the logic of the method is simple. At any given iterate, the method tries to proceed in a SimBA-like manner by testing the change in adversarial loss at fixed-length steps along candidate directions, projected back into the feasible set where necessary. It does so exclusively using normalised loss gradients from the surrogates in the input set (drawn in random order, without replacement), unless and until it has exhausted them at that iterate without success. If this state is reached, the method instead begins to randomly sample, at each iteration, a surrogate (with replacement) and an ODS direction on that surrogate, attempting a SimBA update each time, until an improvement in the loss is realised. Once an ODS direction produces a successful update, the method refreshes the working set of surrogates and resumes using normalised loss gradients only, at the new iterate. The method terminates on finding an adversarial example or on exceeding an upper bound on the query count if one has been specified.

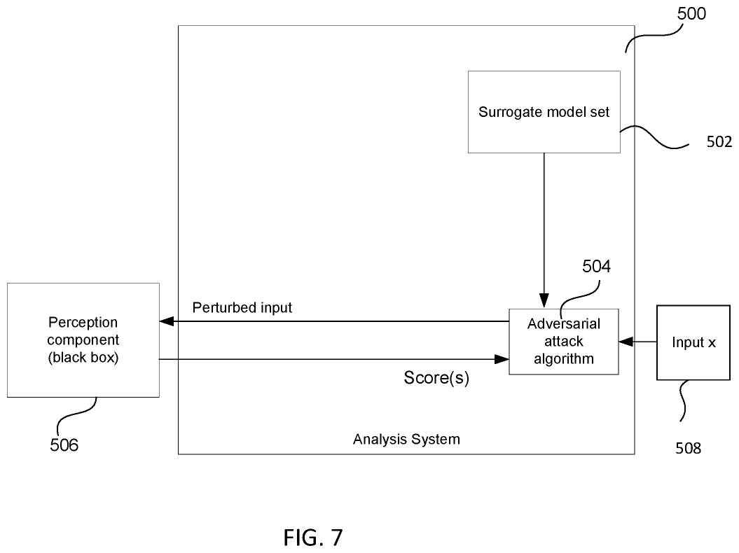

FIG. 7 shows a functional black diagram of a computer system 500 in which the surrogate-based method described above may be implemented.

The computer system is shown to comprise a set of surrogate models 502 (surrogate perception components) from which the adversarial attack algorithm selects a surrogate model based on which a gradient can be computed with respect to the input image 508. The computer system implements the GFCS adversarial attack algorithm (Algorithm 1) described above (labelled 504), which selects a surrogate model from the surrogate model set 502, then computes a gradient of the surrogate attack loss function with respect to the input 508. This gradient is used to perturb the input 507 to generate a perturbed input to a victim perception component 506, which is the ‘victim’ of the adversarial attack method. The perception component generates a score, e.g. a classification or detection score, which is received by the algorithm 504.

The algorithm 504 then performs a comparison of the score generated by the perception component 506 for the perturbed input with the score generated by the perception component 506 for the initial input 508. The algorithm determines, based on this comparison, whether the perturbed input satisfies the promising attack condition. If it does satisfy the promising attack condition, the process is repeated, now perturbing the perturbed input based on the surrogate model gradient. This iterative method is repeated until the perturbed input satisfies some attack objective, wherein the perturbed input becomes an adversarial input. Otherwise, the algorithm samples a surrogate model from the remaining surrogate models of the set 502 and repeats the analysis for the gradients of this surrogate model. If no surrogate models of the set 502 generate a gradient that leads to a perturbed input that satisfies the promising attack condition, the algorithm performs a backup attack process based on a random sampling of the surrogate models and a sampling of directions using output-diversified sampling (ODS).

If the algorithm 504 is able to find adversarial inputs meeting the attack objective, this signals a weakness in the perception component 506, which can be identified and mitigated through an appropriate modification to the perception component 506. For example, this could be part of a performance testing phase, to tune and improve the perception component before it is incorporated in a (physical) robotic system. Such testing is safety-critical in applications such as autonomous driving.

The analysis computer system 500 may take the form of a single computer or a distributed system of multiple computers.

### Example Implementation Details

Details of the implementation of the method described above with reference to Algorithm 1 in experiments, as well as the implementation of competing methods, will now be described.

As explicitly written in Alg. 1 and discussed above, the SimBA-style search is done within a standard PGA projection of the update candidate onto the feasible set, to avoid the common evaluation issue in the literature in which SimBA is punished ex post facto for violating a norm bound that the method was not originally designed to account for. The described method thus avoids this issue by design, but it is further noted that none of the evaluations performed on other methods involve this sort of practice: if a bound is to be imposed, a method should always be modified in a straightforward manner to account for it, rather than being deemed to have failed after the fact. On the other hand, study of the implementations of competing methods has shown that some of them unnecessarily hobble their own performance by using surrogates with domains that differ from that of the target model without appropriately including interpolation between the domains. This typically shows up when InceptionV3, which is trained to accept an input in R^{299*299*3}, is attacked using networks with the more common input domain of R^{224*224*3}: adaptive pooling layers prevent crashing, but do not fix the issue of feature scale mismatch. As such, each surrogate in the present method should be considered to contain a differentiable bilinear interpolation module as an initial layer, thus producing appropriately mapped gradients in the target domain on backpropagation. In the spirit of fair comparison, this option is implemented for competitors as well. Additionally, as of this writing, the public LeBA implementation contains non-standard pre-processing of the input images: this is replaced with standard practice, again to facilitate fair comparison against other methods. Finally, note that when L_{f}(x) is the margin loss, its normalised gradient is just a special case of d_{ODS} (x; f; w) in which w_{c}←1, w_{c}_{ₛ}←−1, and w_{c≠{c}_{ₛ}_{,c}_{ₜ}_{}}←0. In the experimental setup used for the experiments described below, all methods are run on sets of images that, while otherwise randomly selected from the ILSVRC2012 validation set, are guaranteed to be correctly classified by each target network. Thus, there is never any difference between cₛ and the ground-truth label in the untargeted attack case.

### Experiments

GFCS is compared to the methods of Cheng et al. (2019); Tashiro et al. (2020); Yang et al. (2020) by designing a common experimental framework for all methods which represents the essential aspects of the original experiments in the respective source works. Each method is used to perform [symbol] ₂-norm-constrained untargeted attacks against the same 2000 randomly chosen correctly classified ILSVRC2012 validation images per victim network. A maximum query count of 10000 is set per example (beyond which failure is declared), and the [symbol] ₂ bound (enforced using PGA) is set to the commonly chosen \sqrt{0.001D}, where D is the image dimension in the victim network's native input resolution. The victim networks are the pretrained PyTorch (torchvision) implementations of VGG16 (with batch norm), ResNet50, and InceptionV3, representing the union all of the victims in the main experiments of all of the competitors with the exception of the converted Tensorflow-Slim Inception-V4 and Inception-ResNet-V2 models included in Yang et al. (2020). The experiments are repeated for each of two choices of surrogate set: ResNet152 alone (as in Cheng et al. (2019); Yang et al. (2020)), and the set {VGG19, ResNet34, DenseNet121, MobileNetV2} as in Tashiro et al. (2020). The latter is omitted for LeBA (Yang et al. (2020)), whose source code does not admit non-singleton surrogate sets. All surrogate networks are again pretrained torchvision implementations. Parameter values of competitors are as they specify except where, as noted, the parameters have been changed in order to improve their results. LeBA results are presented for “SimBA++”, “train”, and “test” modes, and P-RGF always uses the adaptive coefficient mode. P-RGF and ODS-RGF are based on a PyTorch port of the reference P-RGF code.

TABLE 1
Median query count for state-of-the-art untargeted black-box methods that make use of surrogates. The missing
entry at † indicates the LeBA code crashing before completing the full set of images for ResNet-50.

| | | Median queries [Success rate] | | | | | |
|---|---|---|---|---|---|---|---|
| Surrogates | Method | VGG-16 | | ResNet-50 | | Inception-v3 | |
| 1 | SimBA-ODS | 117 ± 5.1 | [99.45%] | 91.5 ± 3.2 | [99.65%] | 275 ± 14 | [95.10%] |
| | SimBA-ODS [symbol] = 2 | 15 ± 0.7 | [99.65%] | 11 ± 0.4 | [99.90%] | 36 ± 1.9 | [98.50%] |
| | P-RGF | 128 ± 1.1 | [99.95%] | 62 ± 1.2 | [100%] | 282 ± 12 | [99.25%] |
| | P-RGF [symbol] = 0.5, SPD = 10 | 48 ± 2.0 | [99.90%] | 16 ± 0.0 | [99.95%] | 90 ± 4.9 | [99.00%] |
| | ODS-RGF | 44 ± 0.0 | [99.95%] | 33 ± 0.0 | [100%] | 77 ± 2.4 | [99.95%] |
| | SimBA++ | 30 ± 3.0 | [100%] | 5 ± 0.5 | [100%] | 59 ± 3.4 | [99.4%] |
| | LeBA | 8 ± 0.74 | [100%] | —^{†} | | 27 ± 3.1 | [99.45%] |
| | GFCS (ours) | 6 ± 0.3 | [99.90%] | 4 ± 0.4 | [99.85%] | 18 ± 1.1 | [98.60%] |
| | GF, no CS (ablation) | [symbol] | [58.55%] | [symbol] | [75.90%] | (failure) | [38.25%] |
| 4 | SimBA-ODS | 68 ± 2.2 | [99.90%] | 108.5 ± 4.5 | [99.80%] | 227 ± 9.9 | [96.65%] |
| | SimBA-ODS [symbol] = 2 | 10 ± 0.3 | [100%] | 141 ± 0.5 | [99.90%] | 29 ± 1.4 | [100%] |
| | P-RGF | 64 ± 0.6 | [99.95%] | 66 ± 0.5 | [100%] | 232 ± 4.7 | [99.15%] |
| | P-RGF [symbol] = 0.5, SPD = 10 | 16 ± 2.3 | [100%] | 24 ± 1.2 | [100%] | 60 ± 2.1 | [99.60%] |
| | ODS-RGF | 33 ± 0.0 | [100%] | 44 ± 0.0 | [100%] | 77 ± 5.5 | [100%] |
| | GFCS (ours) | 4 ± 0.2 | [100%] | 4 ± 0.0 | [99.95%] | 9 ± 0.5 | [99.40%] |
| | GF, no CS (ablation) | [symbol] | [98.65%] | [symbol] | [96.50%] | [symbol] | [80.20%] |

[symbol]

indicates data missing or illegible when filed

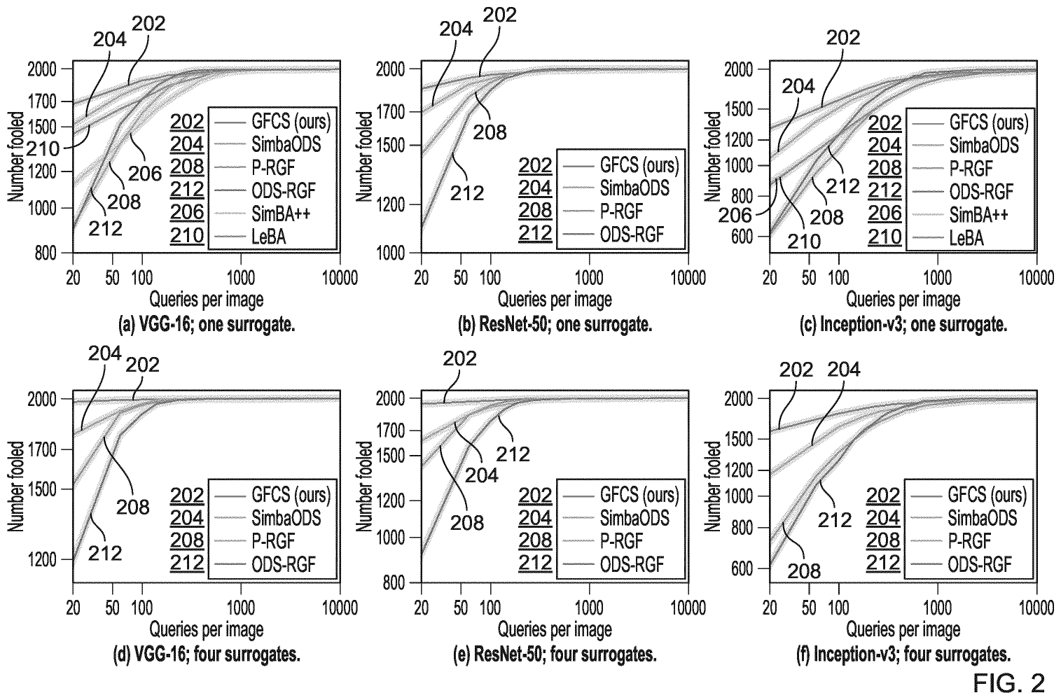

The results of this experiment are displayed in Table 1, which reports attack success rates and median query counts with confidence intervals, and FIG. 2, which plots cumulative success counts against the maximum queries spent per example. Means are not reported, as these are inappropriate for summarising the long-tailed distributions resulting from these methods. Two things are readily apparent in Table 1. First, all of the studied methods have very high success rates on this problem, against all of the victim networks: the lowest rate observed is 95.10% for SimBA-ODS on Inception-v3 with ResNet-152 as the lone surrogate. Second, GFCS 202 is able to achieve a similarly high success rate to all other methods 204-210 with an extremely low median query count, despite its simplicity. This fact can be seen in more detail in the single-surrogate results of FIG. 2 (a), (b), and (c), in which GFCS (202) clearly dominates the low-query regime, and even more strikingly so in the multi-surrogate FIG. 2 (d), (e), and (f). To emphasise: Alg. 1 is a complete statement of the approach as implemented, with L set to the margin loss as described above. There is an additional phenomenon of note: Table 1 also demonstrates the dependence of the performance of existing methods on their own choices of parameter values. Strikingly, most of the empirical benefit of ODS-RGF over the earlier P-RGF is due to the different choice of default parameters in the respective methods: when P-RGF simply uses the default parameters of ODS-RGF, it actually considerably outperforms it in terms of median query count on ResNet-50, at the cost of a 0.05% increase in the single-surrogate failure rate. SimBA-ODS outright benefits, and dramatically so, from an order-of-magnitude increase in its step-size parameter. This, in and of itself, serves as further evidence of the central thesis that transfer (in the context of the assumption of local linearity) is generally pursued too timidly. Of course, one can be too aggressive: see the ablation lines in Table 1 representing the exclusive use of loss gradients, i.e. “GF without the CS”.

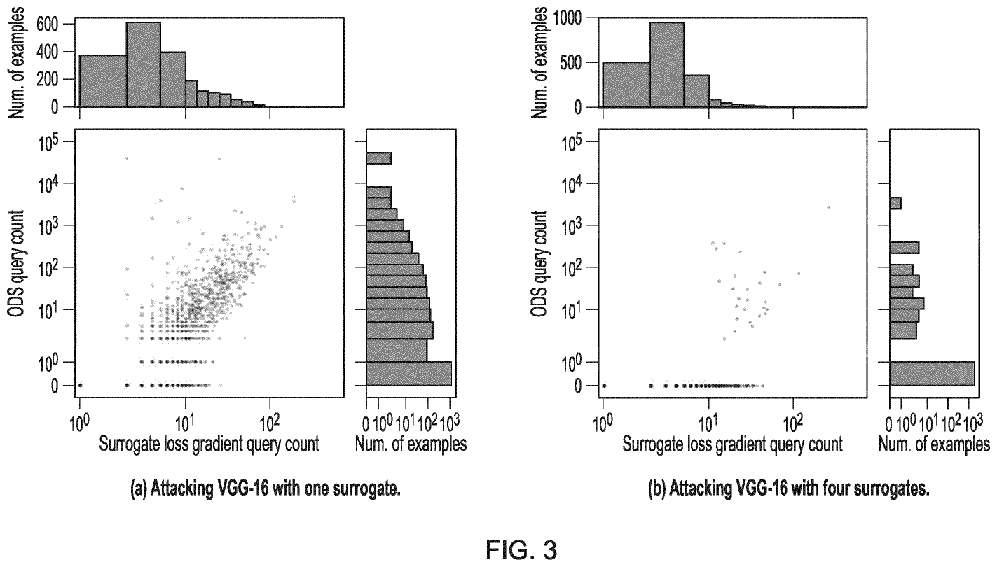

To delve deeper into the results above, each attacked example is plotted as a 2D point whose x-coordinate is the number of queries expended by the surrogate loss block of the algorithm, and whose y-coordinate is the analogous count for the ODS block. This gives the scatter plot of FIG. 3, which is supplemented by marginal histograms corresponding to the axes opposite them. Note that the axes of the main scatter plots and ODS query count marginal histograms are log-log, while the surrogate loss gradient histograms are linear-log; also note the values on each. Some phenomena are readily evident. For one, there is a large fraction of examples (represented by the dense horizontal rows of dots towards the bottom of the plots) that succeed within a very low number of queries (on the order of 1-10), which are entirely or almost entirely due to the surrogate gradient transfer, with ODS used seldom or not at all. As these low-query clusters are extremely dense, the corresponding marginals should be consulted in order to quantify them. For another, the number of examples outside of this regime falls drastically when the four-surrogate set is used instead of ResNet152 on its own, as can be seen by comparing the left and right sides of the figure. It is clear that the number of examples that rely on the interplay between the gradient- and coimage-based direction generators are reduced to a nontrivial (i.e. sufficient to affect the failure rate if not handled) but nonetheless small handful. The respective success rates of each of the two methods in producing an energy increase give further perspective on why direct gradient transfer is preferred: the fraction of SimBA steps accepted as a fraction of steps attempted is significantly higher for the gradient transfer block than the ODS block, averaged over the entire dataset. That is, a priori, it is significantly more likely that a surrogate loss gradient direction will yield a successful step than an ODS direction. This manifests in the scatter plot and marginal histograms as an overall order-of-magnitude difference between surrogate loss gradient queries and ODS queries in the points in the cloud extending away from the dense low-query cluster at the bottom, i.e., the examples that rely on both submethods. That is, when the ODS block is required, it typically requires far more queries to progress the optimiser than in the much more common cases in which the gradient suffices.

The method proposed in Algorithm 1 presents a single hyperparameter: the step length ∈ (line 14), which indicates the length of the perturbations to be attempted at each iterate along its candidate direction. 2.0 is chosen as the default value for experiments by performing a small grid search over a held-out set (disjoint from the 2000 examples used in the experiments). Results for the three architectures used as victim: Inception-V3 (602), ResNet50 (604) and VGG16-BN (606) (and ResNet-152 as the single surrogate) are shown in FIG. 7. Note that the figure has two y-axes and two sets of lines: solid and dashed lines should be considered looking at the axis on the left and right hand side of the plot, respectively. Clearly, better performance can be obtained by separately tuning this hyperparameter for each architecture. Instead, a fixed value is chosen that is reasonable for all models and for both query count and success rate. Note also how it is possible to achieve an even lower query count if one is willing to sacrifice about 1% of the success rate. It is observed that this choice of e is also significantly better than the default one made by SimBAODS (Tashiro et al., 2020) (i.e. 0.2), and results are reported for both in the described experiments.

The above-described adversarial attack method is also tested in the targeted attack scenario. The setup is the same as the experiments described above, except as noted otherwise. For these experiments, instead of the margin loss, the log loss of the target-class softmax score is used, as is often chosen for targeted attacks (including in Tashiro et al. (2020)): L_{f}(x)=log pₜ, where

$${p}_{t} = \frac{{e}^{{f}_{t} ( x )}}{{\sum }_{c} {e}^{{f}_{c} ( x )}} .$$

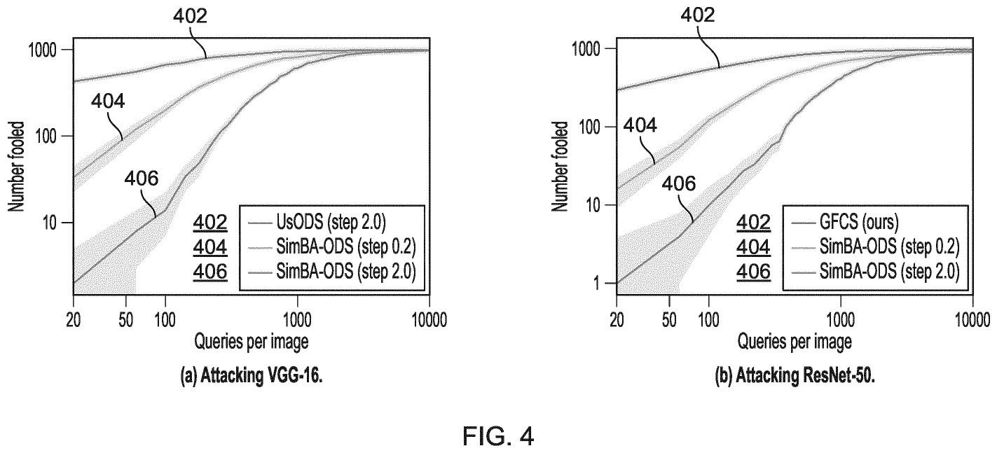

That is, the goal of the attacker is to push the target-class confidence up at the expense of all other classes generally, rather than suppressing a specific source class. Multiple runs are performed for each setting, with the target class for each image chosen at random (uniformly) from all ImageNet classes other than the ground truth. FIG. 4 shows CDFs representing the success at different query counts when performing targeted black-box attacks on VGG-16 or ResNet-50 networks, with four surrogates. Neither Cheng et al. (2019) nor Yang et al. (2020) provides results or code for targeted attacks. While Tashiro et al. (2020) reports targeted attack numbers for both P-RGF (Cheng et al., 2019) and their own ODS-RGF, they do not provide an implementation (publicly or privately) to support either set of results. As noted before, the P-RGF and ODS-RGF results described herein were produced using a port of the public P-RGF repo, which only supports untargeted attacks (a restriction that carries through to the ODS-RGF modification made for the present implementation). The provided SimBA-ODS implementation (404, 406) is thus used, comparing it in isolation to GFCS (402), in which it serves as the backup method. The results are displayed in FIG. 4. As can be seen, even under this more difficult attack scenario, under which the more aggressive transfer strategy of GFCS might be expected to suffer, the present method retains its advantage.

While the targeted attack method of Huang & Zhang (2020) is both powerful and conceptually related, it is architecturally tied to the [symbol] _{∞} norm in its given formulation, and thus not appropriate for [symbol] ₂-bound comparisons. Further, given a trained surrogate, the method requires that one then train the method's adversarial encoder-decoder network on a held-out validation set: in the case of targeted attacks, this must be done per target class, as acknowledged by the authors in the original work. The approach described herein, by contrast, uses the surrogate directly without any issue, on any target class.

The approach described herein, and the ones it is compared against, are all based on priors that are conditioned on the iterate, i.e. gradient information evaluated at the current point. SimBA, on the other hand, effectively encodes location-independent prior information in the form of the basis matrix from which it draws its search directions, and, if appropriate, a prior ordering strategy for searching them. An example, which has been used in other works as well, is the low-frequency DCT basis, which can follow specific orderings if desired. It is well known that there is a sense in which adversarially is location independent, as in Moosavi-Dezfooli et al. (2017). However, location-specific adversaries can be found with much lower norms (Moosavi-Dezfooli et al., 2016; Carlini & Wagner, 2017) when local information is taken into account, even under simple linear assumptions. It is thus clear that while it is important to understand the points made in the universal adversary literature, local information is nonetheless key to finding optimal adversaries. Thus, it is interesting to try to identify what sorts of limits are reached in confining oneself to location-independent priors: here, this is investigated in the context of SimBA. A variant called “SimBA-PCA”¹, which is defined by the approach it takes to generating the SimBA basis matrix. Following the method used in Moosavi-Dezfooli et al. (2017); Jetley et al. (2018), adversarial examples² are gathered over a sample input set as columns in a matrix, then compute that matrix's SVD.
¹SimBA, but with more experience of the world it lives in.
²Various methods of generating the source adversaries have been experimented with, as well as comparing the effects of normalising the directions or not doing so. All approaches yield indistinguishable results. Here, the gradients of random class scores are used.
   That is, the ordered set of vectors are produced that would be expected to represent the l₂-optimal basis are for reproducing the adversarial examples on the given set, when constrained to follow SimBA's iterative adversary-building optimization procedure. This is then compared against SimBA using both the canonical pixel and DCT bases in random order, and GFCS. As an interesting aside, the result of using the SimBA-PCA procedure on raw images directly, i.e. using the principal components of the input data as the search directions, is also included. All of these methods are placed within the same norm-bounded PGA framework.

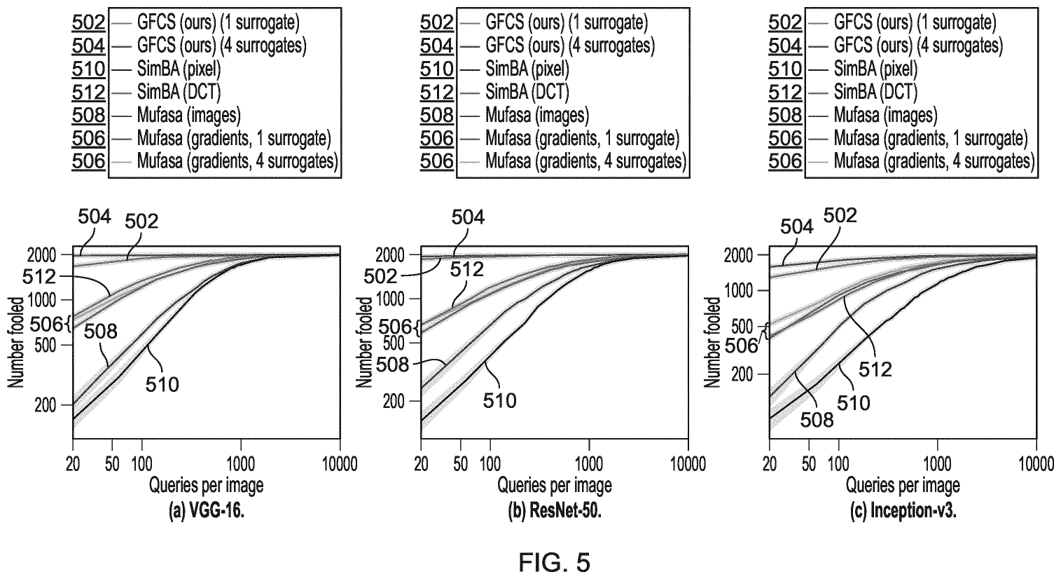

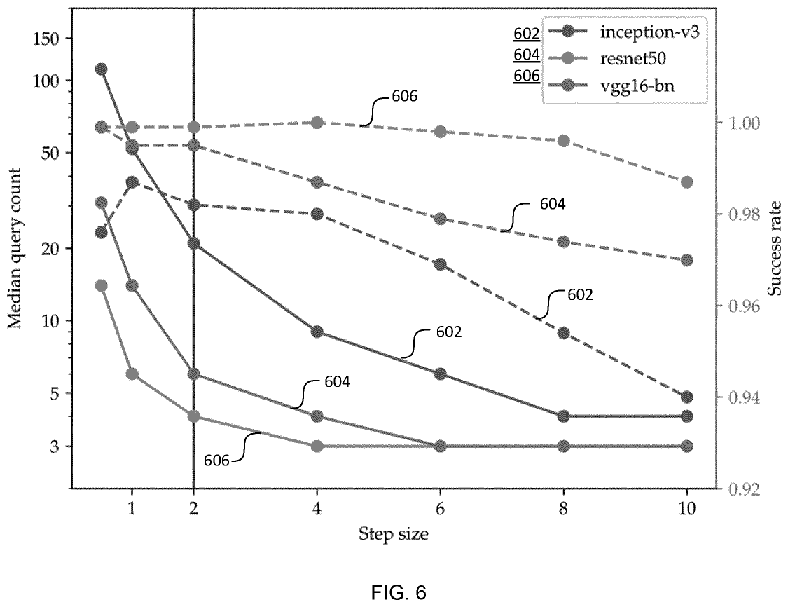

FIG. 5 demonstrates the results of this experiment. As predicted, the SimBA-PCA basis (506) comfortably outperforms the canonical pixel basis (510), as well as the principal image components (508), the latter fact indicating that the information encoded in adversarial directions indeed goes beyond simple correspondence to modes of data variation. One should note, though, that the principal data directions do outperform the naive pixel basis, unsurprisingly revealing nontrivial correlation between modes of data variation and features learned by the network. However, despite forming a “natural adversarial basis”, the SimBA-PCA adversarial singular vector matrix does not outperform the DCT basis (512): their results are very close, but if anything, the DCT basis slightly outperforms. That is, the DCT basis with a suitably tuned frequency count appears to already represent the limit of what a SimBA-style iteration through a single fixed orthonormal basis can accomplish, and the SimBA-PCA procedure has at best recovered an equivalent to it. GFCS (502, 504), on the other hand, is far more efficient than all of the compared methods, demonstrating the performance that is available when it is possible to condition the prior on the iterate, i.e. to use local gradient information. This is one way of viewing why it is that the use of surrogates is as powerful as it is.

One application of transfer-based adversarial attack methods is to determine whether there are noteworthy situations in which the assumption of good feature transfer no longer holds, and the attack no longer suitable: this is tantamount to identifying classes of networks that genuinely learn distinct responses from one another.

In this context, surrogate-based adversarial attacks form the basis of sensitivity analysis: determining whether the victim model is sensitive to the same features/directions as the surrogate(s)).

For example, as part of a development process, a perception system (e.g. an individual component or more complex/modular system) may undergo successive modifications. One use case applies the method to attempt to formulate attacks on one version (e.g. current version) of the perception system (as the victim), using another version(s) (e.g. earlier version(s)) of the perception system as a surrogate(s). In this case, a failure of the method to find a successful transfer attack on the victim indicates a genuine difference in sensitivity between the current and earlier versions-typically, a positive outcome, as it indicates that the latest modification to the perception system has increased its robustness, by successfully removing a (typically unwanted) sensitivity to some input perturbation (whereas a successful attack or attacks might indicate a persisting sensitive issue that has not been resolved and necessitates further modification to the perception system). Alternatively, the method may use a later version as the surrogate to formulate attacks on an earlier version—in this case, failure could indicate a potential new sensitivity that has been introduced in the later version.

In practice, a reduced sensitivity to adversarial attacks generally translates into improved robustness to ‘natural’ perturbations arising from sensor noise, thus reducing misclassifications, missed detections, false positives etc. (as applicable) at runtime. Therefore, the identification and removal of sensitivities based on systematic transfer attacks typically translates into improved runtime performance.

Preferably, the above GFCS method is used, or some variant thereof. However, any surrogate-based attack method may be used in this context.

In a machine learning (ML) context, a perception component (e.g. perception component 506 and surrogate perception component(s) 502 in FIG. 7) may comprise one or more trained perception models for perceiving physical structure. For example, machine vision processing is frequently implemented using convolutional neural networks (CNNs). Such networks are typically trained on large numbers of training images which have been annotated with information that the neural network is required to learn (a form of supervised learning). At training time, the network is presented with thousands, or preferably hundreds of thousands, of such annotated images and learns for itself how features captured in the images themselves relate to annotations associated therewith. This is a form of visual structure detection applied to images. Each image is annotated in the sense of being associated with annotation data. The image serves as a perception input, and the associated annotation data provides a “ground truth” for the image. Perception components can also be applied to other perception modalities, such as lidar or radar inputs, or a combination of different perception modalities (e.g. two or more of image, lidar and radar). Such inputs may be captured using one or more perception sensors (e.g. image capture device(s), radar/lidar unit(s) etc.). Training and analysis of such components can also be performed using “synthetic” inputs, computed using one or more sensor models. Note all description herein relating to “real” inputs applies equally to synthetic inputs designed to approximate real inputs and which exhibit similar statistical properties (e.g. as generated using sensor model(s), such as camera, lidar or radar models, 3D modelling, possibly with techniques such as path tracking and the like to generate synthetic inputs). Sensor data may be real or synthetic unless otherwise indicated. As well as images, CNNs and other forms of perception models/components can be architected to receive and process other forms of perception inputs, such as point clouds, voxel tensors, surface meshes etc., and to perceive structure in both 2D and 3D space. In the context of training generally, a perception input may be referred to as a “training example” or “training input”. By contrast, training examples captured for processing by a trained perception component at runtime may be referred to as “runtime inputs”. Annotation data associated with a training input provides a ground truth for that training input in that the annotation data encodes an intended perception output for that training input. In a supervised training process, parameters of a perception component are tuned systematically to minimize, to a defined extent, an overall measure of difference between the perception outputs generated by the perception component when applied to the training examples in a training set (the “actual” perception outputs) and the corresponding ground truths provided by the associated annotation data (the intended perception outputs). In this manner, the perception input “learns” from the training examples, and moreover is able to “generalize” that learning, in the sense of being able, once trained, to provide meaningful perception outputs for perception inputs it has not encountered during training.

Such perception components 506, 502 are a cornerstone of many established and emerging technologies. For example, in the field of robotics, mobile robotic systems that can autonomously plan their paths in complex environments are becoming increasingly prevalent. An example of such a rapidly emerging technology is autonomous vehicles (AVs) that can navigate by themselves on urban roads. Such vehicles must not only perform complex manoeuvres among people and other vehicles, but they must often do so while guaranteeing stringent constraints on the probability of adverse events occurring, such as collision with these other agents in the environments. In order for an AV to plan safely, it is crucial that it is able to observe its environment accurately and reliably. This includes the need for accurate and reliable detection of real-world structure in the vicinity of the vehicle. An autonomous vehicle, also known as a self-driving vehicle, refers to a vehicle which has a sensor system for monitoring its external environment and a control system that is capable of making and implementing driving decisions automatically using those sensors. This includes in particular the ability to automatically adapt the vehicle's speed and direction of travel based on perception inputs from the sensor system. A fully-autonomous or “driverless” vehicle has sufficient decision-making capability to operate without any input from a human driver. However, the term autonomous vehicle as used herein also applies to semi-autonomous vehicles, which have more limited autonomous decision-making capability and therefore still require a degree of oversight from a human driver. Other mobile robots are being developed, for example for carrying freight supplies in internal and external industrial zones. Such mobile robots would have no people on board and belong to a class of mobile robot termed UAV (unmanned autonomous vehicle). Autonomous air mobile robots (drones) are also being developed.

References herein to components, functions, modules and the like, denote functional components of a computer system which may be implemented at the hardware level in various ways. A computer system comprises execution hardware which may be configured to execute the method/algorithmic steps disclosed herein and/or to implement a model trained using the present techniques. The term execution hardware encompasses any form/combination of hardware configured to execute the relevant method/algorithmic steps. The execution hardware may take the form of one or more processors, which may be programmable or non-programmable, or a combination of programmable and non-programmable hardware may be used. Examples of suitable programmable processors include general purpose processors based on an instruction set architecture, such as CPUs, GPUs/accelerator processors etc. Such general-purpose processors typically execute computer readable instructions held in memory coupled to or internal to the processor and carry out the relevant steps in accordance with those instructions. Other forms of programmable processors include field programmable gate arrays (FPGAs) having a circuit configuration programmable through circuit description code. Examples of non-programmable processors include application specific integrated circuits (ASICs). Code, instructions etc. may be stored as appropriate on transitory or non-transitory media (examples of the latter including solid state, magnetic and optical storage device(s) and the like).

Each of the following is incorporated herein by reference in its entirety:
Abdullah Al-Dujaili and Una-May O'Reilly. Sign bits are all you need for black-box attacks. In 8th International Conference on Learning Representations, ICLR 2020, Addis Ababa, Ethiopia, Apr. 26-30, 2020. OpenReview.net, 2020. URL https://openreview.net/forum?id=SygWOTEFwH.
Maksym Andriushchenko, Francesco Croce, Nicolas Flammarion, and Matthias Hein. Square attack: a query-efficient black-box adversarial attack via random search. In European Conference on Computer Vision, pp. 484-501. Springer, 2020.
Arjun Nitin Bhagoji, Warren He, Bo Li, and Dawn Song. Practical black-box attacks on deep neural networks using efficient query mechanisms. In Proceedings of the European Conference on Computer Vision (ECCV), pp. 154-169, 2018.
Wieland Brendel, Jonas Rauber, and Matthias Bethge. Decision-based adversarial attacks: Reliable attacks against black-box machine learning models. In 6th International Conference on Learning Representations, ICLR 2018, Vancouver, BC, Canada, Apr. 30-May 3, 2018, Conference Track Proceedings. OpenReview.net, 2018. URL https://openreview.net/forum?id=SyZIOGWCZ.
Tom B Brown, Nicholas Carlini, Chiyuan Zhang, Catherine Olsson, Paul Christiano, and Ian Goodfellow. Unrestricted adversarial examples. arXiv preprint arXiv: 1809.08352, 2018.
Thomas Brunner, Frederik Diehl, Michael Truong Le, and Alois Knoll. Guessing smart: Biased sampling for efficient black-box adversarial attacks. In Proceedings of the IEEE/CVF International Conference on Computer Vision, pp. 4958-4966, 2019.
Nicholas Carlini and David Wagner. Towards evaluating the robustness of neural networks. In 2017 ieee symposium on security and privacy (sp), pp. 39-57. IEEE, 2017.
Pin-Yu Chen, Huan Zhang, Yash Sharma, Jinfeng Yi, and Cho-Jui Hsieh. Zoo: Zeroth order optimization based black-box attacks to deep neural networks without training substitute models. In Proceedings of the 10th ACM workshop on artificial intelligence and security, pp. 15-26, 2017.
Shuyu Cheng, Yinpeng Dong, Tianyu Pang, Hang Su, and Jun Zhu. Improving black-box adversarial attacks with a transfer-based prior. Advances in Neural Information Processing Systems, 32:10934-10944, 2019.
Hadi M Dolatabadi, Sarah Erfani, and Christopher Leckie. Advflow: Inconspicuous black-box adversarial attacks using normalizing flows. arXiv preprint arXiv: 2007.07435, 2020.
Ian J Goodfellow, Jonathon Shlens, and Christian Szegedy. Explaining and harnessing adversarial examples. arXiv preprint arXiv: 1412.6572, 2014.
Chuan Guo, Jacob Gardner, Yurong You, Andrew Gordon Wilson, and Kilian Weinberger. Simple black-box adversarial attacks. In International Conference on Machine Learning, pp. 2484-2493. PMLR, 2019a.
Chuan Guo, Jared S Frank, and Kilian Q Weinberger. Low frequency adversarial perturbation. In Uncertainty in Artificial Intelligence, pp. 1127-1137. PMLR, 2020.
Yiwen Guo, Ziang Yan, and Changshui Zhang. Subspace attack: Exploiting promising subspaces for query-efficient black-box attacks. In H. Wallach, H. Larochelle, A. Beygelzimer, F. d'Alch'e-Buc, E. Fox, and R. Garnett (eds.), Advances in Neural Information Processing Systems, volume 32. Curran Associates, Inc., 2019b. URL https://proceedings.neurips.cc/paper/2019/file/2cad8fa47bbef282badbb8de5374b894-Paper.pdf.
Dan Hendrycks, Kevin Zhao, Steven Basart, Jacob Steinhardt, and Dawn Song. Natural adversarial examples. In Proceedings of the IEEE/CVF Conference on Computer Vision and Pattern Recognition, pp. 15262-15271, 2021.
Hossein Hosseini and Radha Poovendran. Semantic adversarial examples. In Proceedings of the IEEE Conference on Computer Vision and Pattern Recognition Workshops, pp. 1614-1619, 2018.
Zhichao Huang and Tong Zhang. Black-box adversarial attack with transferable model-based embedding. In 8th International Conference on Learning Representations, ICLR 2020, Addis Ababa, Ethiopia, Apr. 26-30, 2020. OpenReview.net, 2020. URL https://openreview.net/forum?id=SJxhNTNYwB.
Andrew Ilyas, Logan Engstrom, Anish Athalye, and Jessy Lin. Black-box adversarial attacks with limited queries and information. In International Conference on Machine Learning, pp. 2137-2146. PMLR, 2018.
Andrew Ilyas, Logan Engstrom, and Aleksander Madry. Prior convictions: Black-box adversarial attacks with bandits and priors. In International Conference on Learning Representations, number 2019, 2019.
Saumya Jetley, Nicholas A Lord, and Philip H S Torr. With friends like these, who needs adversaries? In Proceedings of the 32nd International Conference on Neural Information Processing Systems, pp. 10772-10782, 2018.
Yandong Li, Lijun Li, Liqiang Wang, Tong Zhang, and Boqing Gong. Nattack: Learning the distributions of adversarial examples for an improved black-box attack on deep neural networks. In International Conference on Machine Learning, pp. 3866-3876. PMLR, 2019.
Xiaolei Liu, Teng Hu, Kangyi Ding, Yang Bai, Weina Niu, and Jiazhong Lu. A black-box attack on neural networks based on swarm evolutionary algorithm. In Australasian Conference on Information Security and Privacy, pp. 268-284. Springer, 2020.
Yanpei Liu, Xinyun Chen, Chang Liu, and Dawn Song. Delving into transferable adversarial examples and black-box attacks. In 5th International Conference on Learning Representations, ICLR 2017, Toulon, France, Apr. 24-26, 2017, Conference Track Proceedings. OpenReview.net, 2017. URL https://openreview.net/forum?id=Sys6GJqxl.
Chen Ma, Shuyu Cheng, Li Chen, and Junhai Yong. Switching gradient directions for query-efficient black-box adversarial attacks. arXiv preprint arXiv: 2009.07191, 2020.
Seungyong Moon, Gaon An, and Hyun Oh Song. Parsimonious black-box adversarial attacks via efficient combinatorial optimization. In International Conference on Machine Learning, pp. 4636-4645. PMLR, 2019.
Seyed-Mohsen Moosavi-Dezfooli, Alhussein Fawzi, and Pascal Frossard. Deepfool: a simple and accurate method to fool deep neural networks. In Proceedings of the IEEE conference on computer vision and pattern recognition, pp. 2574-2582, 2016.
Seyed-Mohsen Moosavi-Dezfooli, Alhussein Fawzi, Omar Fawzi, and Pascal Frossard. Universal adversarial perturbations. In Proceedings of the IEEE conference on computer vision and pattern recognition, pp. 1765-1773, 2017.
Nicolas Papernot, Patrick McDaniel, Ian Goodfellow, Somesh Jha, Z Berkay Celik, and Ananthram Swami. Practical black-box attacks against machine learning. In Proceedings of the 2017 ACM on Asia conference on computer and communications security, pp. 506-519, 2017.
Anit Kumar Sahu, Satya Narayan Shukla, and J Zico Kolter. Gaussian mrf covariance modeling for efficient black-box adversarial attacks. arXiv preprint arXiv: 2010.04205, 2020.
Yucheng Shi, Siyu Wang, and Yahong Han. Curls & whey: Boosting black-box adversarial attacks. In Proceedings of the IEEE/CVF Conference on Computer Vision and Pattern Recognition, pp. 6519-6527, 2019.
Christian Szegedy, Wojciech Zaremba, Ilya Sutskever, Joan Bruna, Dumitru Erhan, Ian Goodfellow, and Rob Fergus. Intriguing properties of neural networks. In 2nd International Conference on Learning Representations, ICLR 2014, 2014.
Yusuke Tashiro, Yang Song, and Stefano Ermon. Diversity can be transferred: Output diversification for white- and black-box attacks. Advances in Neural Information Processing Systems, 33, 2020.
Chun-Chen Tu, Paishun Ting, Pin-Yu Chen, Sijia Liu, Huan Zhang, Jinfeng Yi, Cho-Jui Hsieh, and Shin-Ming Cheng. Autozoom: Autoencoder-based zeroth order optimization method for attacking black-box neural networks. In Proceedings of the AAAI Conference on Artificial Intelligence, volume 33, pp. 742-749, 2019.
Jie Wang, Zhaoxia Yin, Jin Tang, Jing Jiang, and Bin Luo. Pica: A pixel correlation-based attentional black-box adversarial attack. arXiv preprint arXiv: 2101.07538, 2021.
Chaowei Xiao, Jun-Yan Zhu, Bo Li, Warren He, Mingyan Liu, and Dawn Song. Spatially transformed adversarial examples. In 6th International Conference on Learning Representations, ICLR 2018, Vancouver, BC, Canada, Apr. 30-May 3, 2018, Conference Track Proceedings. OpenReview.net, 2018. URL https://openreview.net/forum?id=HyydRMZC-.
Ziang Yan, Yiwen Guo, Jian Liang, and Changshui Zhang. Policy-driven attack: Learning to query for hard-label black-box adversarial examples. In 9th International Conference on Learning Representations, ICLR 2021, Virtual Event, Austria, May 3-7, 2021. OpenReview.net, 2021. URL https://openreview.net/forum?id=pzpytjk3Xb2.
Jiancheng Yang, Yangzhou Jiang, Xiaoyang Huang, Bingbing Ni, and Chenglong Zhao. Learning black-box attackers with transferable priors and query feedback. Advances in Neural Information Processing Systems, 33, 2020.
Zhengli Zhao, Dheeru Dua, and Sameer Singh. Generating natural adversarial examples. In 6th International Conference on Learning Representations, ICLR 2018, Vancouver, BC, Canada, Apr. 30-May 3, 2018, Conference Track Proceedings. OpenReview.net, 2018. URL https://openreview.net/forum?id=H1BLjgZCb.
Bolei Zhou, Aditya Khosla, Agata Lapedriza, Aude Oliva, and Antonio Torralba. Learning deep features for discriminative localization. In Proceedings of the IEEE conference on computer vision and pattern recognition, pp. 2921-2929, 2016.

1. A computer-implemented method of generating black-box adversarial inputs in an input space of a perception component using one or more surrogate models of the perception component, the method comprising:
receiving an initial input to the perception component and one or more output scores computed by the perception component from the initial input; and
repeatedly perturbing the initial input until an adversarial input is found that satisfies an attack objective when inputted to the perception component, the initial input repeatedly perturbed by:
performing a primary attack process based on the initial input, to compute one or more perturbed inputs, each perturbed input computed in the primary attack process by evaluating a gradient of a surrogate attack loss function based on the initial input, and perturbing the initial input based on the gradient of the surrogate attack loss function, the surrogate attack loss function encoding the attack objective in terms of one or more output scores computed by a surrogate model of the one or more surrogate models;
wherein if a perturbed input of the one or more perturbed inputs is determined to satisfy a promising attack condition, the primary attack process is repeated based on that perturbed input, wherein it is determined whether the perturbed input satisfies the promising attack condition by comparing the one or more output scores computed by the perception component from the initial input with one or more output scores computed by the perception component from the perturbed input;
wherein if the primary attack process terminates without finding any perturbed input satisfying the promising attack condition:
(i) a backup attack process is performed, which is a search of the input space of the perception component for perturbed inputs satisfying the promising attack condition that is randomized but guided by the one or more surrogate models, until a perturbed input satisfying the promising attack condition is found, and
(ii) the primary attack process is repeated based on the perturbed input found to satisfy the promising attack condition in the backup attack process.

2. The method of claim 1, wherein the gradient of the surrogate attack loss function is normalized.

3. The method of claim 1, performed in multiple iterations, wherein, for each iteration, the primary attack process computes the or each perturbed input by applying a perturbation to a starting input for that iteration in a direction in the input space that is defined by the gradient of the surrogate loss function, the starting input being the initial input for a first iteration, and, for every subsequent iteration, the perturbed input found to satisfy the promising attack condition in a previous iteration.

4. The method of claim 3, wherein up to two perturbations are applied to the starting input in each iteration, in the direction of the gradient and in an opposite direction respectively.

5. The method of claim 1, wherein the (or each) perturbation has a fixed magnitude.

6. The method of claim 1, wherein the promising attack condition is defined in terms of a victim attack loss function defined in terms of one or more output scores of the perception component.

7. The method of claim 1, wherein the primary attack process performs a number of queries on a victim, wherein the number of queries is defined by a number of surrogate models and a number of directions considered for each gradient of the surrogate attack loss function.

8. The method of claim 7, wherein two directions are considered for each gradient, for each surrogate model, and wherein 2N queries are performed in the primary attack process in each iteration, where N is the number of surrogate models.

9. The method of claim 1, wherein the backup process is limited by a query cap or other predetermined termination condition.

10. The method of claim 1, wherein the surrogate attack loss function that encodes the attack objective is a deterministic function of one or more output scores of the surrogate model.

11. The method of claim 3, wherein, in each iteration of the primary attack process, each perturbed input is computed by perturbing the starting input of that iteration based on a gradient of a randomized transformation of one or more output scores of a surrogate model of the one or more surrogate models.

12. The method of claim 1, wherein the backup attack process uses an Output-Diversified Sampling (ODS) approach, or a bandit optimiser supplied with surrogate gradients, or surrogate gradients as a biasing prior.

13. (canceled)

14. (canceled)

15. The method of claim 1, wherein a query on the perception component is performed for a given perturbed input to determine whether the given perturbed input fulfils the attack objective and, failing that, whether the given perturbed input satisfies the promising attack condition.

16. The method of claim 1, further comprising identifying and mitigating a problem with the perception component based on adversarial input(s) that has been found.

17. The method of claim 16, further comprising modifying the perception component so that the adversarial input no longer satisfies the attack objective.

18. The method of claim 1, wherein each input comprises one of the following modalities of perception data, or any combination thereof: image data, lidar data or radar data.

19. The method of claim 17, wherein the perception component is for use in a robotic system for perceiving physical structure in an environment in which the robot robotic system is operating and wherein the modified perception component is incorporated in the robotic system.

20. (canceled)

21. The method of claim 17, wherein the modification of the perception component is achieved through re-training, re-architecting or otherwise reconfiguring the perception component.

22.-24. (canceled)

25. A computer system for generating black-box adversarial inputs in an input space of a perception component using one or more surrogate models of the perception component, the computer system comprising:
at least one memory configured to store computer-readable instructions; and
at least one hardware processor coupled to the at least one memory and configured to execute the computer-readable instructions, which upon execution cause the at least one hardware processor to:
receive an initial input to the perception component, the perception component being configured to compute one or more output scores from the initial input; and
repeatedly perturb the initial input until an adversarial input is found that satisfies an attack objective when inputted to the perception component, the at least one hardware processor configured to repeatedly perturb the initial input by:
performing a primary attack process based on the initial input, to compute one or more perturbed inputs, each perturbed input computed in the primary attack process by evaluating a gradient of a surrogate attack loss function based on the initial input, and perturbing the initial input based on the gradient of the surrogate attack loss function, the surrogate attack loss function encoding the attack objective in terms of one or more output scores computed by a surrogate model of the one or more surrogate models;
wherein if a perturbed input of the one or more perturbed inputs is determined to satisfy a promising attack condition, the at least one hardware processor is configured to repeat the primary attack process based on that perturbed input by determining whether the perturbed input satisfies the promising attack condition by comparing the one or more output scores computed by the perception component from the initial input with one or more output scores computed by the perception component from the perturbed input;
wherein if the primary attack process terminates without finding any perturbed input satisfying the promising attack condition, the at least one hardware processor is configured to:
(i) perform a backup attack process, which is a search of the input space of the perception component for perturbed inputs satisfying the promising attack condition that is randomized but guided by the one or more surrogate models, until a perturbed input satisfying the promising attack condition is found, and
(ii) repeat the primary attack process based on the perturbed input found to satisfy the promising attack condition in the backup attack process.

26. A storage medium embodying computer-readable instructions configured, when executed on one or more hardware processors, to:
receive an initial input to a perception component and one or more output scores computed by the perception component from the initial input; and
repeatedly perturb the initial input until an adversarial input is found that satisfies an attack objective when inputted to the perception component, the initial input repeatedly perturbed by:
performing a primary attack process based on the initial input, to compute one or more perturbed inputs, each perturbed input computed in the primary attack process by evaluating a gradient of a surrogate attack loss function based on the initial input, and perturbing the initial input based on the gradient of the surrogate attack loss function, the surrogate attack loss function encoding the attack objective in terms of one or more output scores computed by a surrogate model of one or more surrogate models;
wherein if a perturbed input of the one or more perturbed inputs is determined to satisfy a promising attack condition, the primary attack process is repeated based on that perturbed input, wherein it is determined whether the perturbed input satisfies the promising attack condition by comparing the one or more output scores computed by the perception component from the initial input with one or more output scores computed by the perception component from the perturbed input;
wherein if the primary attack process terminates without finding any perturbed input satisfying the promising attack condition:
(i) a backup attack process is performed, which is a search of an input space of the perception component for perturbed inputs satisfying the promising attack condition that is randomized but guided by the one or more surrogate models, until a perturbed input satisfying the promising attack condition is found, and
(ii) the primary attack process is repeated based on the perturbed input found to satisfy the promising attack condition in the backup attack process.
